(19) United States
(12) Patent Application Publication
(10) Pub. No.: US 2009/0134162 A1
(43) Pub. Date: May 28, 2009

(54) CONTAINER COMPRISING A CLOSING SHEET THAT IS DIRECTLY CONNECTED TO THE WALL

(75) Inventors: Jean-Francois Rene Jouillat, Bauge (FR); Fred Willem Savrij Droste, Warnsveld (NL)

Correspondence Address: CARSTENS & CAHOON, LLP, P O BOX 802334, DALLAS, TX, 75380, US

(73) Assignee: IMPRESS GROUP B.V., DEVENTER (NL)

(21) Appl. No.: 11/577,431

(22) PCT Filed: Oct. 5, 2005
(86) PCT No.: PCT/EP05/10817

§ 371 Date: Oct. 15, 2007

(30) Foreign Application Priority Data
Oct. 25, 2004 (EP) 04077929.0

(51) Int. Cl. B65D 17/34; B65D 41/32; B65D 45/00; B23P 17/04

(52) U.S. Cl. 220/270; 220/266; 220/315; 29/505

(57) ABSTRACT

The invention relates to a container (1) comprising a bottom, a wall (2) and a closing sheet (4) directed from the bottom for closing the container(1), wherein the closing sheet (4) is directly attached to and in contact with the wall (2). The invention also relates to a method for producing a container (1) according to the invention, wherein preferably the closing sheet (4) is first attached to a ring (5), whereafter the ring (5) is arranged to the container (1).

The present invention relates to a container comprising a bottom, a wall and a closing sheet turned away from the bottom for closing the container.

Such containers are known and are for example used for powdered materials such as powdered milk. The containers are filled with a product and a closing sheet is applied to it. However, in order to be able to open the containers quickly, the containers are often provided with a ring which is attached to the wall, such that a part of the ring extends to the inner side of the container. On this part a closing sheet is sealed which is provided with a tab, such that the closing sheet can be separated from the ring. During sterilization or pasteurization the air in the closed container expands. Because of this expansion the sheet is put under pressure. Since the closing sheet is sealed on the ring the pressure is mainly on the seal. Therefore the sheet often separates from the ring making the product in the container useless. Further, both the ring as well as attaching the ring to the container is relatively expensive. Finally, when the closing sheet is removed the opening of the container is relatively small making it hard to completely remove the content from the container.

The present invention attempts to solve the above mentioned problems.

A first aspect of the present invention relates to the container of the above mentioned type characterized in that the closing sheet is directly attached to and in contact with the wall. This has the advantage that a relatively expensive ring does not have to be placed in the container. A further advantage is that the opening of the container is not hindered by the ring extending to the inside of the container. This makes it possible to completely and easily remove the product from the container. The container is preferably made of metal. However, it may also comprise plastic.

In a preferred embodiment the container comprises clamping means for clamping the sheet. The advantage of the clamping means is that the sheet does not separate from the wall. Thus, the integrity of the product in the container is maintained.

The clamping means preferably clamp around a bended part of the upper rim part of the wall to clamp the closing sheet against the wall of the container. This has the advantage that when the container is sterilized or pasteurized and the closing sheet is put under pressure it does not separate from the wall. Another advantage is that the clamping means can also be used for tearing off the sheet when a consumer wishes to consume the product in the container. Further it is an advantage that the clamping means can be attached to the wall by only one action. This has a beneficial effect on the price of the container.

In a preferred embodiment the clamping means comprise a clamping ring. Such a clamping ring has the advantage that is relatively easy to attach and that by using such a ring the closing sheet can be pressed against the wall very firmly. This prevents separation of the closing sheet from the wall when the container is sterilized or pasteurized. It is further preferred when the clamping ring is made of plastic. It is specifically preferred if the clamping ring is provided with a removable part. The advantage of such a removable part is that when it is removed the clamping of the clamping ring is reduced making it easy to remove the closing sheet.

In a preferred embodiment a first part of the clamping ring is located at the inner side of the wall, whereby the closing sheet is clamped against the wall, and a second part of the clamping ring has been folded together with the upper rim of the wall. The advantage of this is that the closing sheet will be clamped firmly against the wall and that only one action for producing the container is necessary. This makes it possible to close the container relatively quick and cheap.

Preferably, the closing sheet is provided with a pulling tab. Such a tab may be used for applying the necessary force to separate the closing sheet from the wall or to tear the sheet along the edge of the clamping ring. It is specifically preferred if the closing sheet is provided with a score line.

In yet another preferred embodiment the clamping means are provided by a folded portion of the upper rim of the wall. This provides for a low-cost container having less parts.

With this embodiment the closing sheet is preferably interposed between the wall and the folded portion. The upper rim can be folded outwardly but also inwardly. With an outwardly folded upper rim the container has the appearance of a conventional sheet metal container.

A second aspect of the present invention relates to a method for producing the above mentioned container.

In a preferred embodiment of the method according to the invention the closing sheet is first attached to the ring, whereafter the ring is arranged to the container.

The invention will now be further described with reference to the following figures. These figures are only meant to illustrate the invention and are in no way intended to limit the scope of the invention.

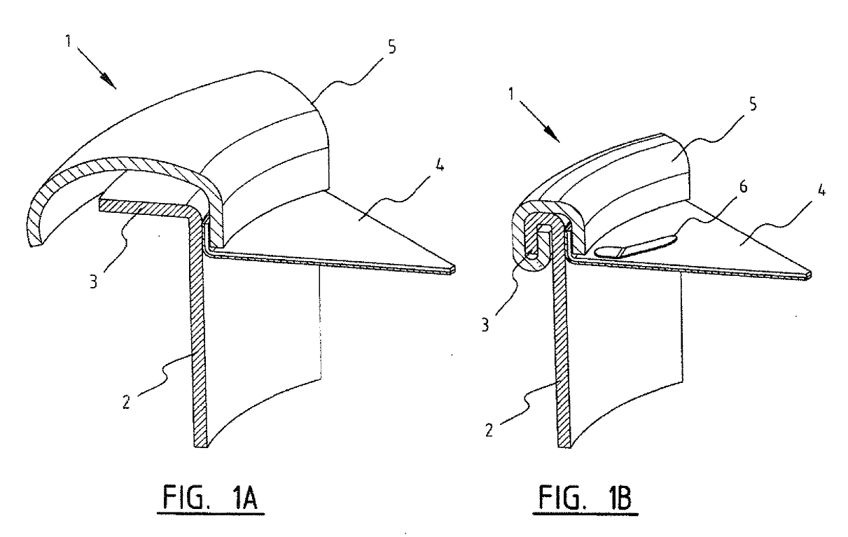

FIG. 1A and 1B show a schematical cross section of a part of the container according to the invention.

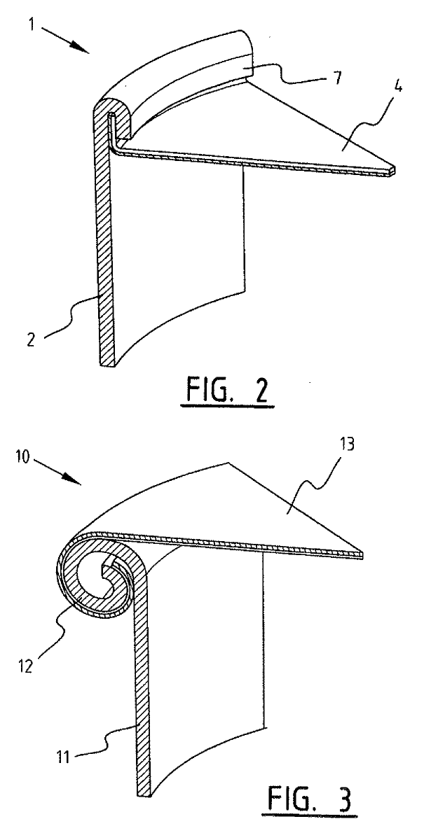

FIG. 2 shows a schematic cross section of a second embodiment of the container according to the invention.

FIG. 3 shows a schematic cross section of a third embodiment according to the invention.

FIG. 1A shows a schematic cross section of a wall 2 of a container 1. The wall 1 of the container 2 comprises a part 3 extending to the outside of the container. Further a closing sheet 4 is placed against a part of the inner side of the wall 2 of the container 1. A clamping ring 5 is placed over the part of the closing sheet 4 which is placed against the wall 2. This clamping ring 5 is folded together with the part 3 of the wall 2 of the container 1 extending to the outside as is shown in FIG. 1B. The closing sheet 4 is pressed against the inner side of the wall 2 of the container 1. Furthermore, the closing sheet 4 is provided with a pulling tab 6. This tab 6 can be used for separating or tearing off the closing sheet 4 from the container 1. Preferably, the part of the closing sheet that comes into contact with the wall 2 is provided with an adhesive such that a good connection between the wall 2 and the closing sheet 4 is obtained.

Upon manufacturing this embodiment one can choose to first attach the closing sheet 4 to the wall and then to arrange the clamping ring 5. It may also be more suitable to first attach the closing sheet 4 to the clamping ring 5 and then to arrange the clamping ring 5 including the closing sheet 4 to the wall of the container.

FIG. 2 shows a cross section of the wall 2 of a container 1 according to the invention. The upper part 7 of the wall 2 has been bent inwardly such that the closing sheet 4 is clamped against the inner side of the wall 2. The part of the closing sheet 4 that comes into contact with the wall is preferably provided with an adhesive such that a good connection between the wall 2 and the closing sheet 4 is obtained.

FIG. 3 shows a third embodiment 10 according to the invention. This embodiment 10 has a upstanding wall 11 and an upper rim 12. A foil sheet 13 is attached to the upper rim 12 and the upper rim 12 is than curled outwardly.

1. Container comprising a bottom, a wall and a closing sheet directed from the bottom for closing the container, characterized in that the closing sheet is directly attached to and in contact with the wall.

2. Container according to claim 1, characterized in that the container comprises clamping means for clamping the sheet against the wall

3. Container according to claim 1, characterized in that the clamping means clamp around a bended part of an upper rim part of the wall.

4. Container according to claim 3, characterized in that the clamping means comprise a clamping ring.

5. Container according to claim 4, characterized in that a first part of the clamping ring is located at the inner side of the wall, whereby the closing sheet is clamped against the wall, and that a second part of the clamping ring has been folded together with the upper rim part of the wall .

6. Container according to claim 1, characterized in that the closing sheet is provided with a pulling tab.

7. Container according to claim 1, characterized in that the closing sheet is provided with at least one score line.

8. Container according to claim 2, wherein the clamping means are provided by a folded portion of the upper rim of the wall .

9. Container according to claim 8, wherein the closing sheet is interposed between the wall and the folded portion.

10. Container according to claim 8, wherein the upper rim is folded outwardly.

11. Method for producing a container according to claim 1.

12. The method of claim 11 for producing a container, said method farther in accordance to claim 4, and further wherein the closing sheet is first attached to the ring, whereafter the ring is arranged to the container.
